(19) United States
(12) Patent Application Publication
(10) Pub. No.: US 2026/0163650 A1
(43) Pub. Date: Jun. 11, 2026

(54) CASCADED SWAPPING SCHEDULER FOR ENTANGLEMENT DISTRIBUTION NETWORK

(71) Applicant: Cisco Technology, Inc., San Jose, CA (US)

(72) Inventors: Hassan Shapourian, San Mateo, CA (US); Jiapeng Zhao, Kenmore, WA (US); Shahrooz Pouryousef Delezi, Amherst, MA (US)

(21) Appl. No.: 18/653,540

(22) Filed: May 2, 2024

(51) Int. Cl. H04B 10/70; B82Y 20/00

(52) U.S. Cl. CPC H04B 10/70; H04B 10/27; H04Q 2011/0073

(57) ABSTRACT

A method comprises: at a node on path of a quantum network that leads from a source to a destination, propagating quantum entanglement hop-by-hop along the path toward the destination by: establishing a first entanglement link with a previous-hop node on the path; determining a next-hop node on the path based on the destination; attempting to establish a second entanglement link with the next-hop node; and upon receiving an acknowledgement from the next-hop node indicating that the second entanglement link is established, performing an entanglement swap on the first entanglement link and the second entanglement link to establish a third entanglement link between the previous-hop node and the next-hop node.

### TECHNICAL FIELD

The present disclosure relates to propagating quantum entanglement across a quantum network.

### BACKGROUND

Quantum entanglement distribution networks are a promising architecture to enable the quantum Internet, where end users can exchange qubits and access remote quantum clouds (e.g., remote quantum servers, sensors, etc.). However, distributing quantum entanglement across a large-scale network is challenging due to signal attenuation over distance (e.g., photon loss in an optical fiber). A possible solution may employ a central network controller that closely controls generation of (short-range) quantum entanglement between routers and stitches together such entanglement links using entanglement-swapping to establish long-range entanglement between the end users. That is, the central network controller orchestrates the routing, scheduling, and entanglement-swapping. This central control scheme introduces new challenges in network routing and scheduling (e.g., to determine when and where swaps are to be performed). For instance, assume several user node pairs demand quantum entanglement at the same time. This causes resource contention and requires many rounds of classical communication among the routers. Moreover, employing the central network controller to orchestrate the routing, scheduling, and entanglement-swapping is not a scalable solution. For example, the processing workload scales polynomially O(N^{x}) with the number of network nodes or routers N.

### BRIEF DESCRIPTION OF THE DRAWINGS

FIG. 1 is a block diagram of a quantum network and a quantum node (also referred to simply as a “node”) of the quantum network in which embodiments directed to hop-by-hop quantum entanglement link construction from a source to a destination along a network path may be implemented, according to an example embodiment.

FIG. 2 shows first operations of a method of propagating quantum entanglement hop-by-hop along a path of the nodes of the quantum network from a source to a destination, according to an example embodiment.

FIG. 3 shows second operations of the method of propagating quantum entanglement hop-by-hop along the path of the quantum network, according to an example embodiment.

FIG. 4 shows third operations of the method of propagating quantum entanglement hop-by-hop along the path of the quantum network, according to an example embodiment.

FIG. 5 shows fourth operations of the method of propagating quantum entanglement hop-by-hop along the path of the quantum network, according to an example embodiment.

FIG. 6 shows fifth operations of the method of propagating quantum entanglement hop-by-hop along the path of the quantum network, according to an example embodiment.

FIG. 7 shows sixth operations of the method of propagating quantum entanglement hop-by-hop along the path of the quantum network, according to an example embodiment.

FIG. 8 shows seventh operations of the method of propagating quantum entanglement hop-by-hop along the path of the quantum network, according to an example embodiment.

FIG. 9 shows eighth operations of the method of propagating quantum entanglement hop-by-hop along the path of the quantum network, according to an example embodiment.

FIG. 10 is a flowchart of a method of propagating quantum entanglement hop-by-hop along a path of a quantum network from a source toward a destination, according to an example embodiment.

FIG. 11 shows nodes of the quantum network that are configured for multiplexed routing and generating entanglement, to propagate multiplexed quantum entanglement hop-by-hop along a path, according to an embodiment.

FIG. 12 shows first operations for the multiplexed routing and generating entanglement, according to an embodiment.

FIG. 13 shows second operations for the multiplexed routing and generating entanglement, according to an embodiment.

FIG. 14A shows third operations for the multiplexed routing and generating entanglement, according to an embodiment.

FIG. 14B shows fourth operations for the multiplexed routing and generating entanglement, according to an embodiment.

FIG. 15 shows fifth operations for the multiplexed routing and generating entanglement, according to an embodiment.

FIG. 16A shows sixth operations for the multiplexed routing and generating entanglement, according to an embodiment.

FIG. 16B shows seventh operations for the multiplexed routing and generating entanglement, according to an embodiment.

FIG. 17 shows eighth operations for the multiplexed routing and generating entanglement, according to an embodiment.

FIG. 18A shows ninth operations for the multiplexed routing and generating entanglement, according to an embodiment.

FIG. 18B shows tenth operations for the multiplexed routing and generating entanglement, according to an embodiment.

FIG. 19 is a flowchart of a method of multiplexed routing and generating entanglement, according to an example embodiment.

FIG. 20 is an illustration of a packet forwarded from a previous node to a node, according to an example embodiment.

FIG. 21 is an illustration of a response message to the packet of FIG. 20, according to an example embodiment.

FIG. 22 illustrates a hardware block diagram of a computing device that may perform functions associated with operations performed in the embodiments presented herein, according to an example embodiment.

### DETAILED DESCRIPTION

### Overview

In an embodiment, a method comprises: at a node on path of a quantum network that leads from a source to a destination, propagating quantum entanglement hop-by-hop along the path toward the destination by: establishing a first entanglement link with a previous-hop node on the path; determining a next-hop node on the path based on the destination; attempting to establish a second entanglement link with the next-hop node; and upon receiving an acknowledgement from the next-hop node indicating that the second entanglement link is established, performing an entanglement swap on the first entanglement link and the second entanglement link to establish a third entanglement link between the previous-hop node and the next-hop node.

In another embodiment, A method comprises: at a node on path of a quantum network, propagating parallel quantum entanglement hop-by-hop along the path by: establishing M inbound entanglement links with a previous node on the path, where M>2; attempting to establish N outbound entanglement links with a next node on the path, where N>2, resulting in establishing P outbound entanglement links with the next node; and upon determining which of the N outbound entanglement links are the P outbound entanglement links, entanglement-swapping the P outbound entanglement links with P inbound entanglement links of the M inbound entanglement links, to entangle the P outbound entanglement links with P inbound entanglement links, to entangle the P next quantum memories with P previous quantum memories of the M previous quantum memories. In an example, this includes entanglement-swapping on a minimum of (M, P) number of entanglement links.

### Example Embodiments

Embodiments presented herein provide efficient scheduling protocols for entanglement-swapping across quantum networks, which may include optical quantum networks. The embodiments include hop-by-hop quantum entanglement link construction to generate short-range entanglement links one-by-one from a sender (i.e., a source of traffic) to a receiver (i.e., a destination of the traffic) via intermediate routers along a network path. Each router independently chooses a next router (i.e., a next hop) toward the destination based on local traffic considerations, and without accessing next hop information from a central network controller. Hence, the embodiments allow for distributed routing and scheduling and present a scalable solution that overcomes disadvantages described above. Further advantages are evident from the ensuing description.

The embodiments rely on quantum concepts, such as “qubits,” “Bell pairs,” and “Bell-state measurements.” Briefly, a quantum bit (qubit) is a basic unit of information in quantum computing and a counterpart to the bit (binary digit) in classical computing. A qubit can exhibit quantum properties such as quantum entanglement. In an example, generally, a qubit may be represented by a photon, although other types of qubits are possible. In the photon example, the qubit encodes a property of the photon, such a vertical polarization or a horizontal polarization of the photon. A Bell pair is a pair of qubits in any type of maximally entangled state referred to as a Bell state. In the photon example, the Bell pair is represented by a pair of entangled photons, i.e., first and second entangled photons. A Bell-state measurement is a joint measurement between the states of two qubits (e.g., photonic qubits) that determines which of four Bell states the pair of qubits is in.

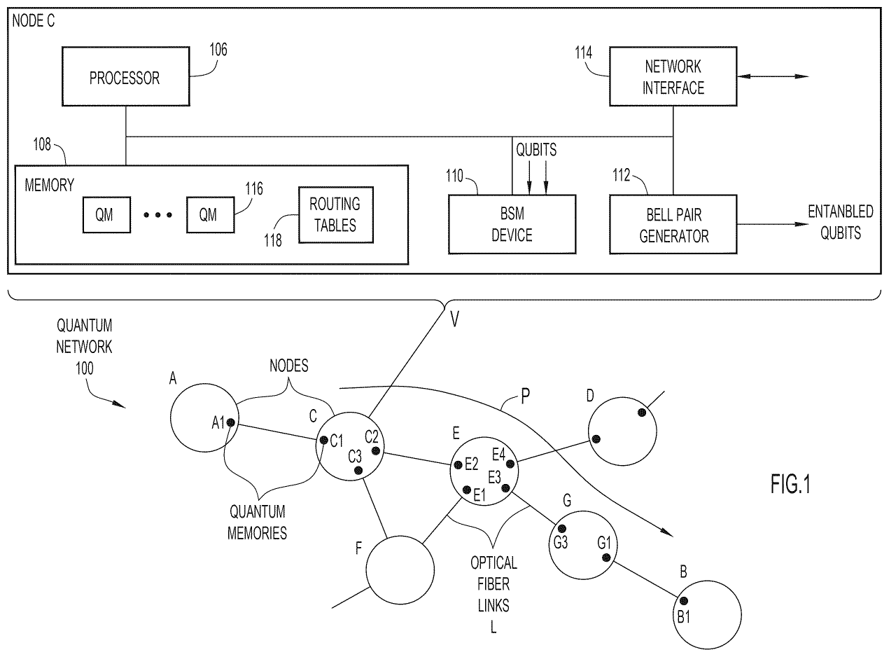

FIG. 1 is a block diagram of an example quantum network 100 in which embodiments directed to hop-by-hop quantum entanglement link construction from a source to a destination along a network path may be implemented. The embodiments result in end-to-end quantum entanglement of quantum information (e.g., qubits) from the source to the destination. Quantum network 100 may include or form part of one or more quantum wide area networks (QWANs), such as the Internet, and one or more quantum local area networks (QLANs). Quantum network 100 is implemented in the context of an optical network, although other types of non-optical networks may be employed to implement the embodiments. Quantum network 100 includes multiple quantum nodes A-G connected to each other over fiber-optic links L. The quantum nodes may be referred to collectively simply as “nodes” and individually as a “node.” In an example, nodes A-G represent network devices, such as routers and/or switches, which may be implemented as physical or virtual devices (e.g., as applications hosted on servers). Nodes A-G combine quantum and classical (i.e., non-quantum) networking functions to propagate entanglement swaps (and thus entanglement) hop-by-hop across quantum network 100. Thus, quantum network 100 may be considered a hybrid quantum-classical network, and nodes A-G may be considered hybrid quantum-classical nodes.

In the example of FIG. 1, nodes A and B may represent end users or endpoints of quantum network 100, and the other nodes may be considered intermediate nodes. For example, node A may represent a source of traffic including quantum information in the form of qubits, and node B represents a destination for the traffic. The source (e.g., node A) originates the traffic toward the destination (e.g., node B) and intermediate nodes C, E, and G forward the traffic and propagate quantum entanglement hop-by-hop (and link-by-link) in sequence from the source to the destination along a network path P that includes nodes A, C, E, G, and B. More specifically, nodes A, C, E, G, and B use sequential entanglement-swapping over their intermediate or next-hop links to propagate quantum entanglement from node A to node B over network path P, which results in end-to-end quantum entanglement between qubits in nodes A and B. In the ensuing description, “quantum entanglement” may be referred to simply as “entanglement.”

Nodes A-G implement one or more network routing protocols modified to support the above-mentioned forwarding of traffic (e.g., data packets) including quantum payloads across quantum network 100 from the source to the destination. Example network protocols include, but are not limited to, the Internet Protocol (IP)/the transmission control protocol (TCP) (IP/TCP), the routing Information Protocol (RIP), the Open Shortest Path First (OSPF), the Exterior Gateway Protocol (EGP), the Border Gateway Protocol (BGP), the Intermediate System-to-Intermediate System (IS-IS). Such known or hereafter developed network protocols are modified as described herein to implement the embodiments.

According to the network protocols, nodes A-G exchange discovery messages with each other to construct and maintain local forwarding or routing tables that store routes to next hop destinations. Nodes A-G may construct their local routing tables independent of a centralized network controller. Once the routing tables are populated, when a given node receives traffic (including the quantum payloads) addressed to the destination, the given node performs a look-up in its local routing table(s) for a route to a next hop (i.e., a next node) along the network path toward the destination, and then forwards the traffic to the next hop. The routing table(s) provides the node with all of the forwarding information used by the node to forward traffic, so that the node can forward the traffic independent of, and without communicating with, the centralized network controller. The forwarding process repeats sequentially for each next hop along the network path until the traffic reaches the destination. In this way, the nodes forward the traffic hop-by-hop along the network path until the traffic reaches the destination. Also, according to embodiments presented herein, nodes A-G propagate entanglement of quantum information hop-by-hop using entanglement-swapping, without interacting with the centralized network controller, as described below.

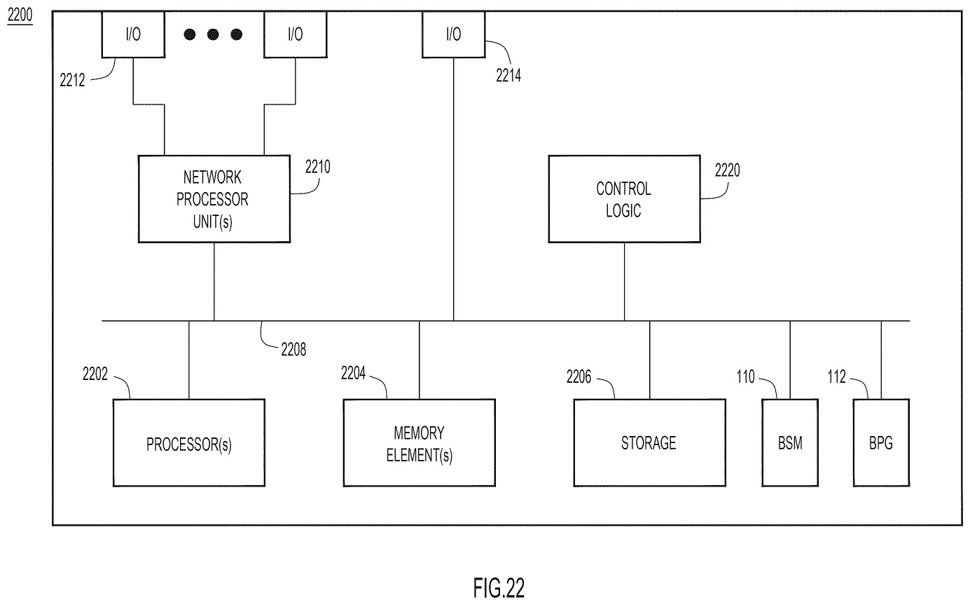

FIG. 1 shows further details of node C in an exploded view V, which is useful for describing the embodiments presented herein. Exploded view V may be considered representative of each of nodes A-G. That is, each of nodes A-G may implement the functions/components of exploded view V. Additional details of each node are described below in connection with FIG. 22. As shown in the exploded view, node C (and the other nodes of quantum network 100) includes classical and quantum features. Node C includes a processor 106, a memory 108, a Bell-state measurement (BSM) device 110 (e.g., a quantum gate (QG) and measurement devices) to perform Bell-state measurements on pairs of concurrent qubits provided to the QG under control of the processor, a Bell pair generator (BPG) 112 to generate Bell pairs or pairs of entangled qubits under control of the processor, and a network interface 114 to communicate with adjacent nodes over optical fiber links L. BSM device 110 may be implemented in accordance with any known or hereafter developed techniques or devices that perform a Bell-state measurement on a pair of qubits, including a pair of entangled photons. For example, BSM device 110 includes a quantum circuit applied to two qubits as follows: a controlled NOT (CNOT) gate on first (control) and second (target) qubits, a Hadamard gate on the first qubit, and measuring both qubits. The quantum circuit can be directly applied to quantum memories or mediated by photons. BPG 112 may be implemented in accordance with any known or hereafter developed techniques or devices that generate a Bell pair of qubits, including Bell pair of photons. For example, BPG 112 can be realized in a nonlinear media that is pumped by a laser field (via spontaneous down conversion or four-wave mixing) or by quantum emitters (e.g., quantum dot emitters).

Memory 108 includes quantum memories 116 to store quantum information in the form of qubits (e.g., one qubit per quantum memory) and routing tables 118 (e.g., an IP look-up table) to store routing information (e.g., routes) derived using the above-mentioned network protocols. Quantum memories can be realized in solid state systems in the form of color centers (defects), or ensemble of ions, or in the form of vapor cells containing a dilute gas. The aforementioned components operate under control of processor 106 to support the embodiments presented herein.

In the example of FIG. 1, solid-shaded dots inside the circles that represent each node represent quantum memories. For example, nodes A, C, E, G, and B respectively include quantum memories (A1), (C1, C2), (E2, E3), (G1, G3), and (B1). In the ensuing description, a “quantum memory” and a “qubit” stored in the quantum memory may be synonymous and used interchangeably, depending on context. For example, quantum memory A1 and a qubit stored in the quantum memory may be used interchangeably. Also, when quantum memories are entangled, the qubits stored in the quantum memories are entangled.

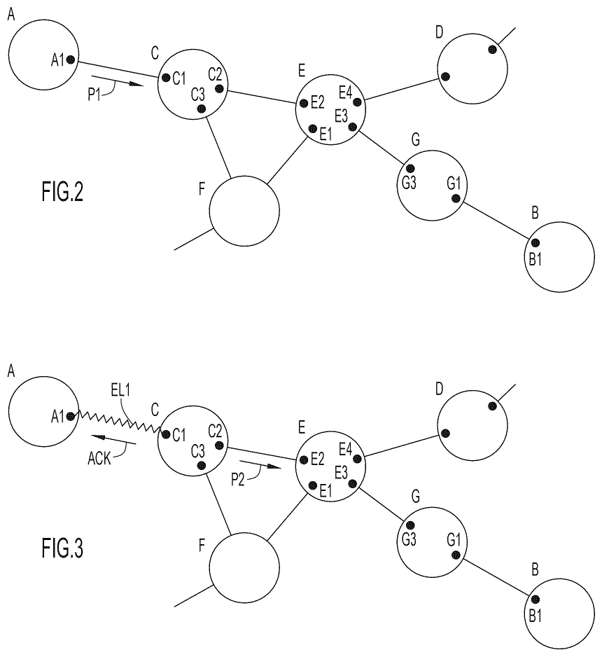

FIGS. 2-9 collectively show an example process of routing and generating entanglement (i.e., propagating the entanglement through entanglement swaps) along network path P between nodes A and B of quantum network 100, according to an embodiment. FIGS. 2-9 show a sequence of operations and/or states of quantum network 100 as the process progresses hop-by-hop. The process shown in FIGS. 2-9 assumes that nodes A-G have performed network protocols to populate their local routing tables (e.g., routing tables 118) with routes to next hops based on a destination IP address (or a subnet on which the destination IP address resides). In the example, intermediate or repeater nodes C, E, and G have populated their local routing tables with next-hop routes leading to node B.

Referring to FIG. 2, node A generates a Bell pair including a first qubit and a second qubit that are entangled (e.g., first and second entangled photons). Node A prepares a packet (also referred to as a “frame”) including a header and a quantum payload. In an example, the packet may generally conform to a format of an IP packet, modified as described herein. The header includes a source IP address for node A and a destination IP address for node B, as well as calibration information for the quantum payload, e.g., phase and polarization reference. The quantum payload includes one qubit out of the Bell pair (e.g., the first qubit). At P1, node A sends the packet to node C, in an attempt to establish entanglement (i.e., an entanglement link) with node C. Node A stores the other qubit of the Bell pair (e.g., the second qubit) in quantum memory (QM) A1. Generally, an entanglement link includes logical and/or physical connections between two entities and across which a pair or entangled qubits are separated.

Upon receiving the packet from node A, node C calibrates the quantum payload and prepares to use a quantum memory (e.g., QM C1) to store the quantum payload. Node C examines the packet to determine whether the quantum payload (i.e., the qubit) is present. This can be achieved via a heralding signal generated by the quantum memory. When the qubit is not present (i.e., no qubit was received), node C sends a response message, for example, a negative acknowledgement (NACK) (not shown), back to node A to indicate an unsuccessful transmission of the qubit, and that the attempt to establish entanglement with node C failed. The above-described process of creating a Bell pair, storing one qubit of the Bell pair, and transmitting the other qubit of the Bell pair, repeats until the transmission is successful (as described below).

Referring to FIG. 3, when node C determines that the qubit is present, node C sends a response message (e.g., an acknowledgement (ACK)) back to node A indicating that the qubit was received, and stores the qubit in QM C1. This creates an entanglement link EL1 (represented by a zig-zag) between nodes A and C (also referred to as “A-C entanglement”). Entanglement link EL1 entangles QMs A1 and C1 (i.e., the qubits stored in the QMs) across the fiber-optic link between nodes A and C. In this way, the ACK indicates to node A that the attempt to establish entanglement with node C is successful.

Node C performs a lookup of its local routing table(s) based on the destination IP address (listed in the header of the packet received from A) to retrieve a route to a next-hop node (referred to simply as a “next hop”) along the network path (also referred to simply as a “path”) toward the destination. There may be multiple paths, in which case node C may choose a path randomly, or may employ a more complicated scheme to select the next hop. In the example, node C chooses node E as the next hop.

Node C prepares/generates a Bell-pair, stores one qubit of the Bell pair in QM C2, and populates a quantum payload of a packet with the other qubit. At P2, node C forwards the packet with the qubit to node E. Upon receiving the packet from node C, node E performs operations similar to node C. Node E determines whether the packet from node C includes a qubit. If not (i.e., when the qubit is lost), node E sends a NACK (not shown) to node C indicating the failed attempt. Upon receiving the NACK, node C resets QM C2, generates another Bell pair, encodes a qubit of the Bell pair in another packet, and forwards the same to node E; which process repeats until node E receives a qubit from node C.

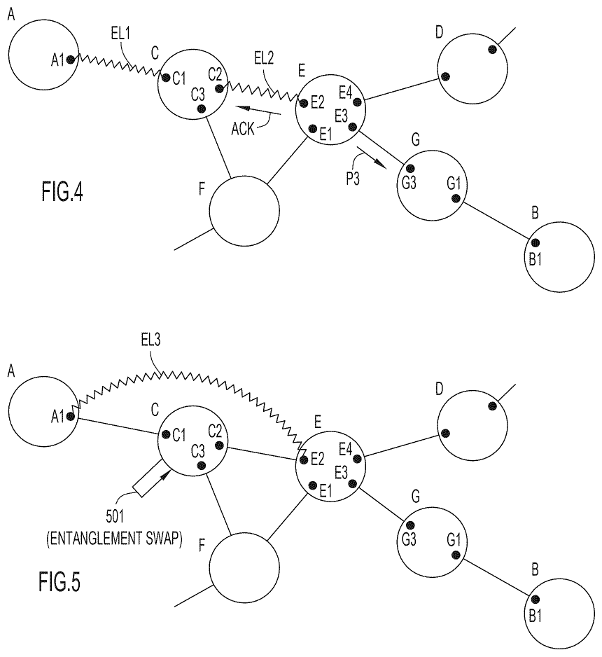

Referring to FIG. 4, when node E determines there is a qubit in the packet from node C, node E sends an ACK to node C acknowledging receipt of the qubit, and stores the qubit in QM E2. This establishes an entanglement link EL2 between nodes C and E (i.e., entangling QMs C2 and E2). Node E prepares a Bell pair, stores one qubit of the Bell pair in QM E3, creates a packet, and encodes a quantum payload of the packet with the other qubit. Node E determines that node G is the next hop based on a lookup of the local routing table using the destination IP address in the packet received from node C. At P3, node E forwards the packet to node G.

Referring to FIG. 5, upon receiving the ACK from node E (as shown in FIG. 4), at 501, node C performs a Bell-state measurement (i.e., an entanglement swap) on QMs C1 and C2, which directly entangles QMs A1 and E2, to form entanglement link EL3 between nodes A and E (i.e., entanglement link A-E). To perform the entanglement swap, BSM device 110 (e.g., a quantum circuit comprising CNOT, Hadamard gate, and measurement apparatus) of node C (shown in FIG. 1) performs the Bell-state measurement on the qubit pair stored in QMs C1 and C2 together, when the BSM device is applied to the qubits. QMs C1 and C2 are released. Node C sends to node A a BSM report in the form of a classical signal that includes an outcome of the Bell-state measurement (i.e., which one of the four Bell states are observed in the Bell-state measurement) and that also includes a destination IP address for node A.

Upon receiving the packet sent by node E at P3 (from FIG. 4), node G determines whether the packet contains a qubit. When the qubit is lost, node G sends a NACK (not shown) to node E indicating that no qubit was received. Then, node E resets QM E3, creates a Bell pair, stores one qubit of the Bell pair, creates a packet that contains another qubit from the Bell pair, and forwards the packet to node G. This process repeats until node G receives a qubit from node E.

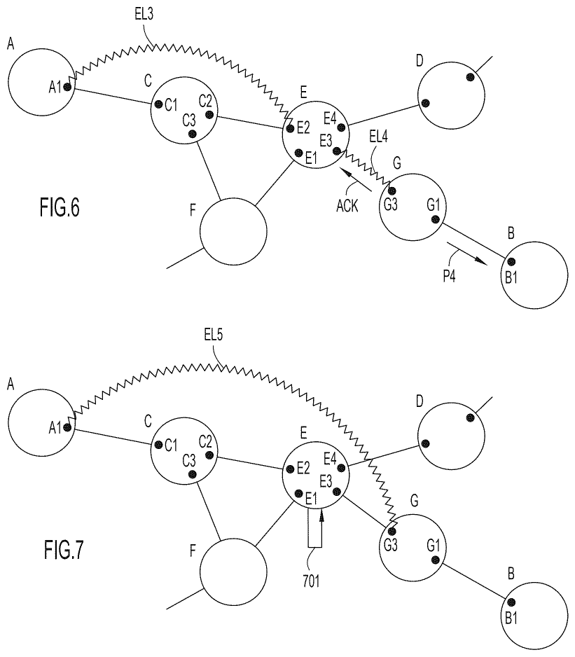

Referring to FIG. 6, when node G determines that the packet sent by node E includes a quantum payload (i.e., a qubit), node G sends an ACK to node E. Node G stores the qubit in QM G3, which creates an entanglement link between nodes E and G (i.e., entangling QMs E3 and G3). Node G prepares a Bell pair, stores one qubit of the Bell pair in QM G1, creates a packet, populates the packet with the other qubit of the Bell pair and, at P4, forwards the same to node B.

Referring to FIG. 7, upon receiving the ACK from node G (as shown in FIG. 6), at 701, node E performs an entanglement swap by performing a Bell-state measurement on QMs E2 and E3, which creates an entanglement link EL5 between nodes A and G (i.e., entangling QMs A1 and G3. Node E sends to node C a BSM report destined for the source (e.g., node A). That is, node E sends the BSM report to node A via node C.

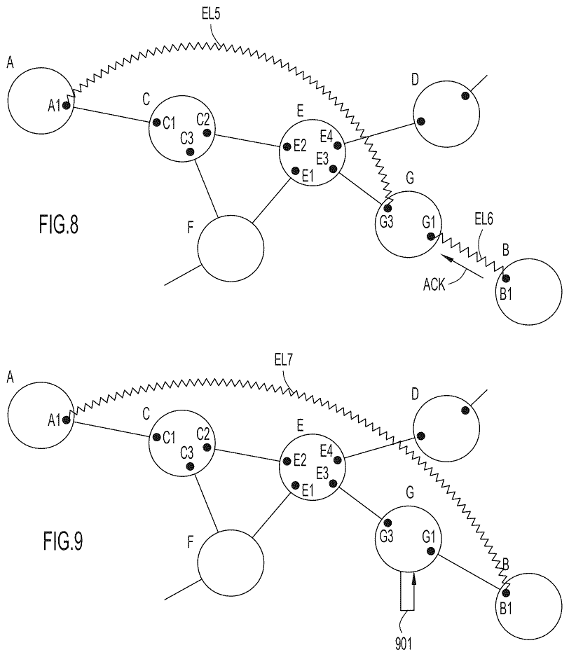

Referring to FIG. 8, node B determines whether there is a qubit in the packet from node G. When there is no qubit, node G repeats the operations outlined above until a qubit arrives at node B. When there is a qubit, node B sends an ACK to node G and stores the qubit in QM B1, which creates an entanglement link EL6 between nodes G and B (i.e., entangling QMs G1 and B1).

Referring to FIG. 9, upon receiving the ACK from node B (see FIG. 8), at 901, node G performs a Bell-state measurement on QMs G3 and G1, to connect/entangle entanglement links E5 and E6, to form end-to-end entanglement link EL7 between nodes A and B (i.e., entangling qubits stored in QMs A1 and B1). Node G sends to node E a BSM report destined for the source.

In the above-described sequence of operations, each node attempts to establish entanglement (i.e., an entanglement link) with a next node using the following operations: creating a Bell pair; storing one qubit of the Bell pair in a local QM; and transmitting the other qubit of the Bell pair to the next node, under the assumption that, when the next node receives the other qubit, the next node stores the same in a local QM of the next node, which establishes/completes successful entanglement (i.e., the entanglement link) between the nodes. An ACK from the previous node confirms/indicates that the next node received the other qubit, stored (or will store) the same in a QM, and thus completed successful node-to-node entanglement. On the other hand, a NACK from the previous node indicates that the attempt failed, which triggers the node to repeat the attempt until the ACK is received. Given that quantum memories have a finite coherence time (beyond which an entanglement link is no longer valid), various policies can be implemented to discard a given sequence of operations which takes a longer time (compared to the quantum memory coherence time) and to then start a new process from the first node. For example, a hard cutoff can be implemented at each node so that each node stops attempting to establish an entanglement link when the cutoff time is exceeded, after which the node sends a restart signal/request to all previous nodes (including the source node) to restart the process from the beginning.

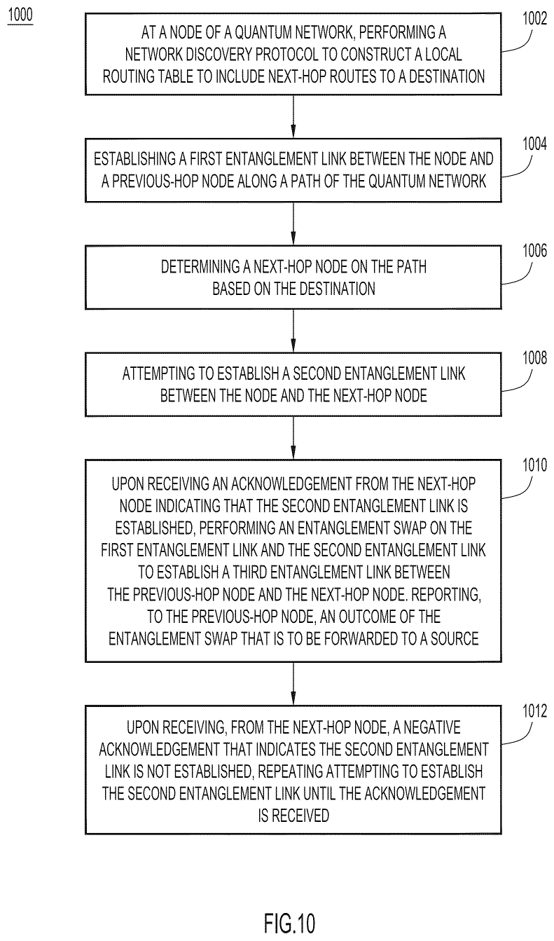

FIG. 10 is a flowchart of an example method 1000 of propagating quantum entanglement hop-by-hop along a path of a quantum network that leads from a source toward a destination. The operations of method 1000 are described above in connection with FIGS. 2-9. Method 1000 may be performed by/at each node (referred to as a “node” in the description of FIG. 10 below) of successive nodes along the path from the source to the destination until the destination is reached, thereby establishing quantum entanglement from the source to the destination. The operations of method 1000 may be performed independent of, and without interacting with, a network controller (e.g., a centralized network controller) that is separate from each node.

Operation 1002 includes performing a network discovery protocol to construct a local routing table to include next-hop routes to the destination.

Operation 1004 includes establishing first entanglement (i.e., a first entanglement link) between a previous-hop node (which may be the source or an intermediate node) along the path and the node. This includes establishing the first entanglement between a first QM of the previous-hop node and a second QM of the node. For example, the node may perform operations to include:
a. Receiving from the previous-hop node a packet that includes a header and a quantum payload. The header includes an address of the destination. The quantum payload includes a second qubit of a first Bell pair that includes a first qubit and the second qubit. The first qubit of the first Bell pair is stored in a first QM of the previous-hop node.
b. storing the second qubit in a second QM of the node.

Operation 1006 includes determining a next-hop node on the path based on the address of the destination. For example, the node performs a lookup in a local routing table of a route to the next-hop node based on the address of the destination, and without acquiring information about the route from the separate network controller.

Operation 1008 includes attempting to establish second entanglement (i.e., a second entanglement link) between the node and the next-hop node. This includes attempting to establish the second entanglement between a third QM of the node and a fourth QM of the next-hop node. To do this, the node may perform operations that include:
a. Creating a second Bell pair that includes a third qubit and a fourth qubit. For example, a processor of the node controls/causes BPG 112 of the node to create the second Bell pair.
b. storing the third qubit in the third QM.
c. Transmitting the fourth qubit to the next-hop node to be stored in the fourth QM.

Operation 1010 includes, upon receiving an ACK from the next-hop node indicating that the second entanglement is established (or will be established), entangling the pervious-hop node and the next-hop node This may include performing an entanglement swap on the second QM and the third QM of the node to establish third entanglement (i.e., a third entanglement link) between the first QM of the previous-hop node and the fourth QM of the next-hop node. The entanglement swap includes performing a Bell-state measurement on the second QM and the third QM. For example, the processor of the node controls/causes BSM device 110 to perform the Bell-state measurement, which creates a third Bell pair entangling the previous-hop node and the next-hop node. In terms of entanglement links, operation 1010 includes performing an entanglement swap on the first entanglement link between the previous-hop node and the node and the second entanglement link between the node and the next-hop node, to form the third entanglement link between the previous-hop node and the next-hop node. This includes performing a Bell-state measurement of the first entanglement link and the second entanglement link. In addition, the node sends to the previous node a BSM report destined for the source. The BSM report indicates an outcome of the entanglement swap.

Operation 1012 includes upon receiving, from the next-hop node, a NACK (instead of the ACK of operation 1010) that indicates the second entanglement is not (or will not be) established, repeating attempting to establish the second entanglement until the ACK is received.

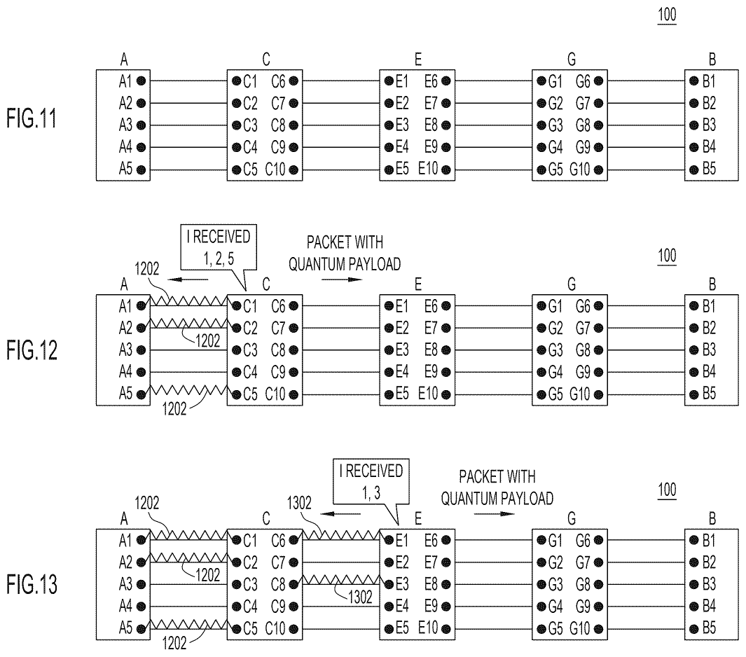

FIGS. 11-18B collectively show an example multiplexing process that builds on the process shown in FIGS. 2-9. The multiplexing process includes/performs multiplexed routing and generating entanglement between nodes A and B along parallel/concurrent or multiplexed links between the nodes. FIGS. 11-18B show a sequence of operations and/or states of quantum network 100 as the multiplexing process progresses hop-by-hop. In the ensuing description, “multiplexed,” “concurrent” and “in parallel” are synonymous and may be used interchangeably.

FIG. 11 shows nodes A, C, E, G, and B connected along the path (or at least configured to determine the path, hop-by-hop) from node A to node B. The nodes are each configured with multiple parallel QMs. For example, node A includes QMs A1-A5, node C includes QMs C1-C10, and so on.

Referring to FIG. 12, node A prepares 5 Bell pairs (one per QM), stores one qubit of each in QMs A1-A5, and sends the rest to node C in parallel. The multiple qubits may be sent through the same fiber-optic link by placing the qubits one after another in a multiple qubit quantum payload of the packet transmitted to node C, or by introducing a tagging scheme. Node C receives the packet, checks the quantum payload to determine which of the qubits have arrived, and stores them in corresponding ones of QMs C1-C5 (also referred to as “inbound QMs”). If the quantum payload is empty (none of the qubits arrived), node C sends a request message to node A that request node A to repeat the aforementioned process. Otherwise, node C prepares 5 new Bell pairs, stores one qubit of each in QMs C6-C10 (also referred to as “outbound QMs”), and sends one qubit of each in a new packet to node E. In the example of FIG. 12, the text “I received 1, 2, 5” represents that:
a. Node A created a first Bell pair, stored a first qubit of the first Bell pair in QM A1, sent the second qubit of the first Bell pair to C, which received the second qubit and transmitted an ACK to node A. The ACK indicates to node A that node C receive the second qubit and stored (or will store) the same in QM C1.
b. Node A created a second Bell pair, stored a first qubit of the second Bell pair in QM A2, sent the second qubit of the second Bell pair to C, which received the second qubit and transmitted an ACK to node A (indicating that the second qubit was received and is (or will be) stored in QM C2.
c. Node A created a fifth Bell pair, stored a first qubit of the fifth Bell pair in QM A5, sent the second qubit of the fifth Bell pair to C, which received the second qubit (and transmitted an ACK to node A) indicating the receipt, and that the second qubit is or will be stored in QM C5.
d. Qubits for the third and fourth Bell pairs are lost, and node C sent NACKs to node A indicating the losses.

Operations (a)-(c) establish three parallel or multiplexed entanglement links 1202 between nodes A and C, specifically, between QM pairs (A1, C1), (A2, C2), and (A5, C5), shown as zigzags in FIG. 12.

Referring to FIG. 13, node E receives the packet from node C, checks which qubits have arrived, and stores them in QMs E1-E5. If the quantum payload is empty (none of qubits arrive), node E requests node C to repeat the process. In the example of FIG. 13, node E receives two qubits, and stores them in QMs E1 and E3. This establishes 2 entanglement links 1302 between nodes C and E, specifically, between QM pairs C6, E1 and C8, E3. Node E prepares 5 new Bell pairs, stores one qubit of each in QMs E6-E10, and sends one qubit of each in a new packet to node G.

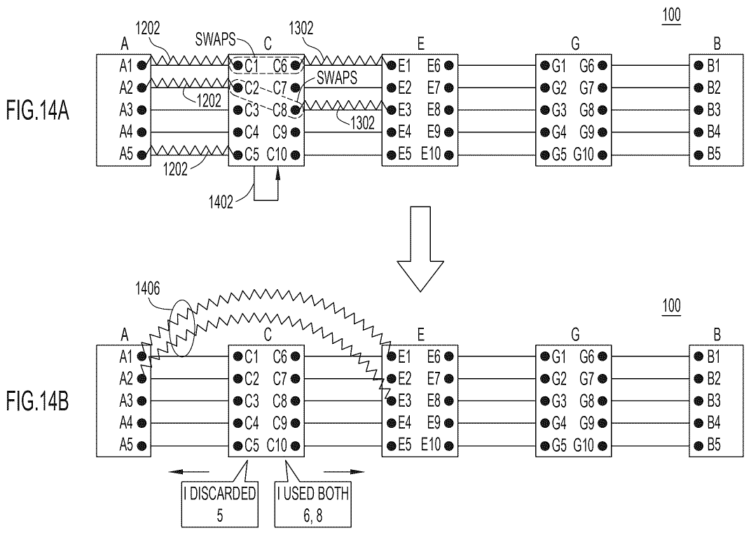

Referring to FIG. 14A, upon receiving ACKs from node E, at 1402, node C performs Bell-state measurements (entanglement swaps) on the successful entanglement links and discards the remaining unpaired Bell pairs. For example, node C performs Bell-state measurements on QM pairs C1, C6 and C2, C8, which entangle QM pairs A1, E1 and A2, E3. Node C sends to node A BSM reports for corresponding ones of the Bell-state measurements. With reference to FIG. 14B, the Bell-state measurements performed at 1402 (show in FIG. 14A) form entanglement links 1406 between nodes A and E. Node C also informs nodes E and A about which pairs are used/discarded (e.g., shown as messages “I discarded 5” and “I used both 6, 8”).

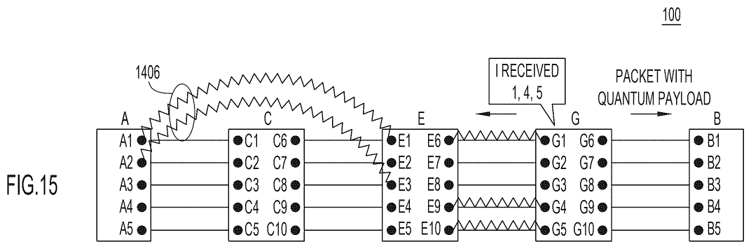

With reference to FIG. 15, node G receives the packet from node E (see FIG. 13), checks which qubits have arrived, and stores them in QMs G1-G5. In this case, node G receives three qubits from node E and stores them in QMs G1, G4, and G5, creating entangled links between QM pairs (E6, G1), (E9, G4), and (E10, G5). If the quantum payload is empty (none of qubits arrive), node G asks node E to repeat the process. Node G prepares 5 new Bell pairs, stores one qubit of each in QMs G6 to G10, and sends one qubit of each in a new packet to node B.

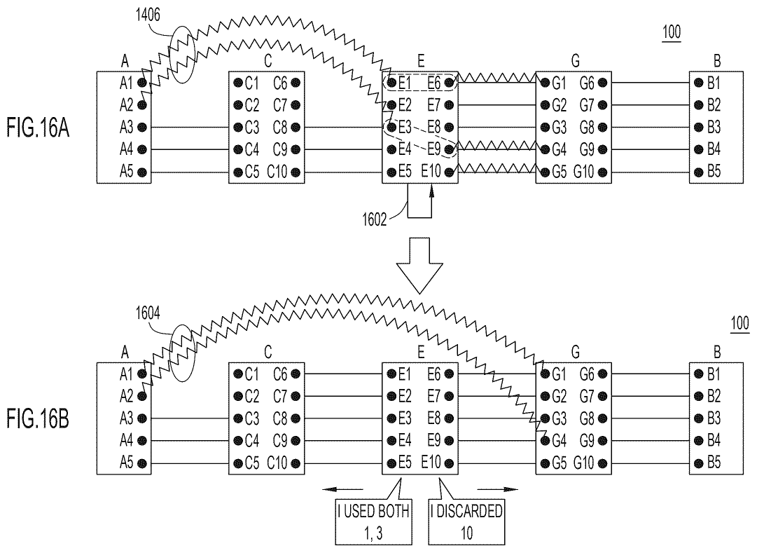

With reference to FIG. 16A, upon receiving ACKs from node G (shown in FIG. 15), node E performs Bell-state measurements (entanglement swaps) 1602 on the successful entanglement links and discards the remaining unpaired Bell pairs. For example, node E performs Bell-state measurements on QM pairs E1, E6 and E3, E9, which entangles QM pairs A1, G1 and A2, G4 of nodes A and G. Node E sends to node A (via node C) BSM reports for the Bell-state measurements. With reference to FIG. 16B, Bell-state measurements performed at 1602 (from FIG. 16A) form entanglement links 1604 between nodes A and G. Node E also informs node G and node C about which pairs are used/discarded. This “backward message” passes through previous repeaters until it arrives at node A, because node A benefits from knowing how many QMs are still connected.

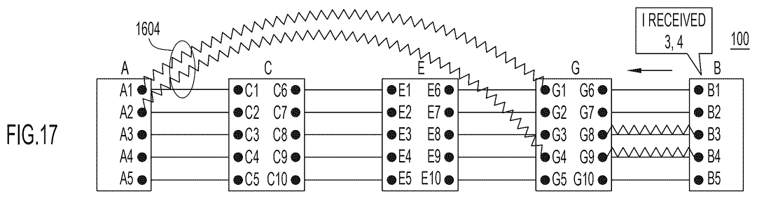

Referring to FIG. 17, node B receives the packet from node G (see FIG. 15), checks which qubits have arrived, and store them in QMs B1 to B5. If the quantum payload is empty (none of qubits arrive), node B asks node G to start the process again. Otherwise, node B sends ACKs to node G. In the example, node G receives two qubits, acknowledges their receipt to node G, and stores the qubits in QMs B3 and B4, thereby entangling QM pairs G8, B3 and G9, B4.

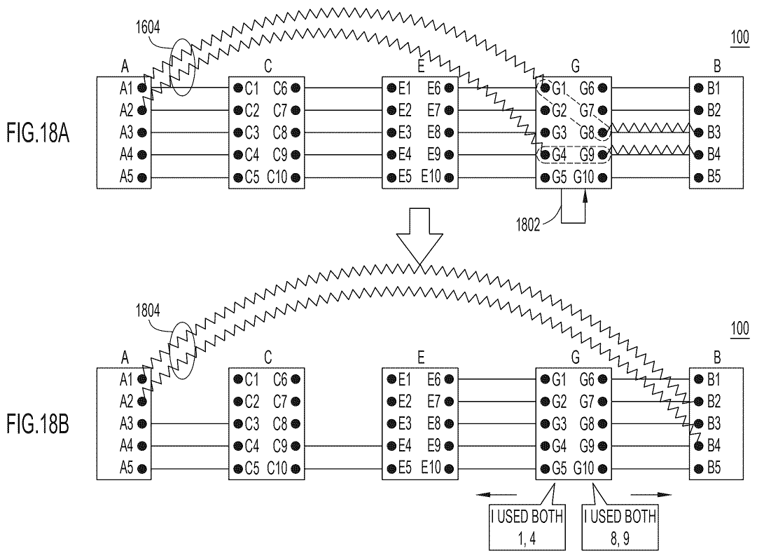

Referring to FIG. 18A, upon receiving the ACKs from node B (shown in FIG. 17), at 1802, node G performs Bell-state measurements (entanglement swaps) on the successful entanglement links and discards the remaining unpaired Bell pairs. For example, node G performs Bell-state measurements on QM pairs G1, G8 and G4, G9, which entangles QM pairs A1, B3 and A2, B4 between nodes A and B. Node G sends to node A (via node E) BSM reports for the Bell-state measurements. With reference to FIG. 18B, the entanglement swap forms end-to-end entanglements links 1804 entangling QMs in node A and node B. Node G also informs node B and node E about which pairs are used/discarded. The backward message goes through previous repeaters and is relayed to node A. Node A then knows which QMs are directly entangled with QMs of node. This generates two end-to-end Bell pairs.

The example of FIGS. 11-18B employs five inbound and five outbound memories in each node by way of example, only. A practical example may include on the order of 1000-10,000 QMs (as opposed to five), which significantly boosts performance. In addition, congestion control may be used when multiple users sharing multiple paths and repeaters (i.e., intermediate nodes). The above-described protocol(s) can also be enriched with quantum error correction for a more robust performance, where the inbound/outbound quantum memories are not only entangled with their corresponding photon but also with each other. In this case, an elementary entanglement link includes a Bell-pair of two logical qubits (i.e., a logical Bell pair), and the Bell-state measurement is a logical Bell-state measurement. The multiplexing scheme can further be applied to a series of logical qubits.

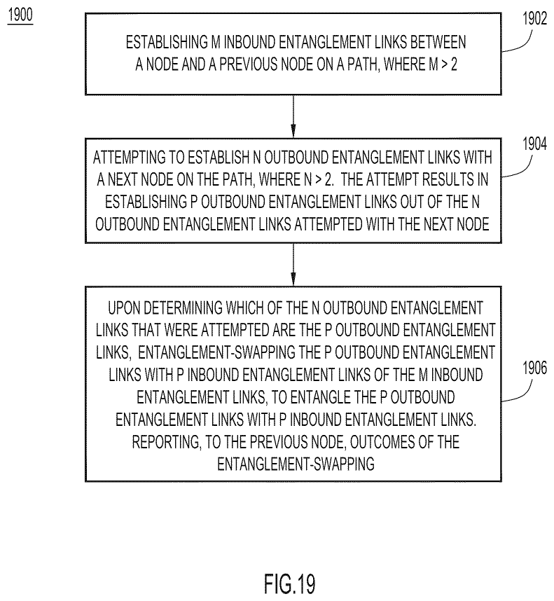

FIG. 19 is a flowchart of an example method 1900 of multiplexed routing and generating entanglement. Method 1900 propagates parallel quantum entanglement (entanglement links) hop-by-hop along a path of a quantum network from a source toward a destination. Operations of method 1900 are described above in connection with FIGS. 11-18B. The operations of method 1900 may be performed/repeated by/at each node (referred to as a “node” in the description of FIG. 19 below) of successive nodes along the path from the source to the destination until the destination is reached, thereby establishing parallel quantum entanglement from the source to the destination, i.e., to achieve multiplexed entanglements (i.e., entanglement links) from end-to-end along the path. The operations of method 1900 may be performed independent of, and without interacting with, a network controller that is separate from each node.

Operation 1902 includes establishing M inbound entanglement links between the node and a previous node on the path, wherein M>2. This may include entangling M inbound quantum memories of the node with M previous quantum memories of the previous node, which may further include. This includes:
a. Receiving, in parallel from the previous node, M inbound qubits of M Bell pairs created in the previous node; and
b. Storing the M inbound qubits in the M inbound quantum memories.

Operation 1904 includes attempting to establish N outbound entanglement links with a next node on the path, where N>2. This may include attempting to entangle N outbound quantum memories of the node with N next quantum memories of the next node. The attempt results in establishing P outbound entanglement links out of the N outbound links with the next node. In an example P<N. In terms of quantum memories, the attempt results in entangling P outbound quantum memories out of the N outbound quantum memories with P next quantum memories of the next node, which may include the following operations:
a. Creating N Bell pairs that include N first qubits and N second qubits.
b. Storing the N first qubits in the N outbound quantum memories of the node.
c. Transmitting, to the next node, the N second qubits in parallel to be stored in N quantum memories of the next node.

Operation 1906 includes determining which of the N outbound entanglement links that were attempted are the P outbound links (i.e., identifying the P outbound links). In terms of quantum memories, this includes determining which of the N outbound quantum memories of the node are the P outbound quantum memories. Then, entanglement-swapping the P outbound entanglement links with the same number, P, of inbound entanglement links (among the M inbound entanglement links) (assuming that P<M), and sending to the previous node BSM reports of entanglement-swapping outcomes. In terms of quantum memories, this may include entanglement-swapping the P outbound quantum memories (i.e., performing entanglement swaps) with the same number, P, of inbound quantum memories (among the M inbound quantum memories) of the node. This results in entangling the P outbound entanglement links with the P inbound entanglement links. In terms of quantum memories, this results in entangling the P next quantum memories of the next node with P previous quantum memories of the M previous quantum memories in the previous node. The entanglement-swapping includes performing Bell-state measurements on pairs of the P inbound entanglement links (e.g., the P inbound quantum memories) and the P outbound entanglement links (e.g., the P outbound quantum memories). In an example, Bell-state measurements are only performed on a minimum of (M, P) pairs of quantum memories.

Determining which of the N outbound entanglement links are the P outbound entanglement links (e.g., which of the N outbound quantum memories of the node are the P outbound quantum memories) includes:
a. Receiving, from the next node, an individual acknowledgement for each of the P outbound entanglement links that is established (e.g., for each of the P second qubits out of the N second qubits that is received by the next node).
b. Identifying each of the P outbound entanglement links (e.g., each of the P outbound quantum memories out of the N quantum memories of the node) based on each individual acknowledgement.

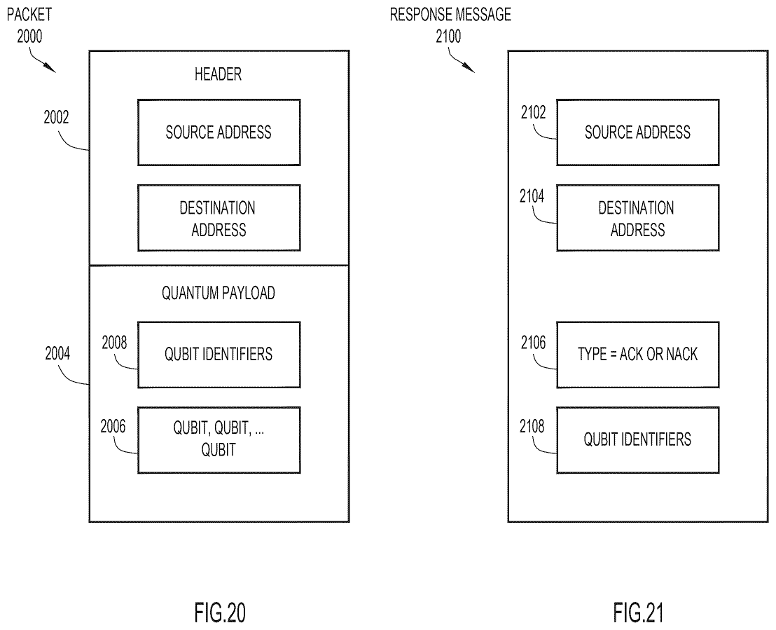

FIG. 20 is an illustration of an example packet 2000 (e.g., a quantum-modified IP packet) sent from a previous node to a node. Packet 2000 includes an IP header 2002 and a quantum payload 2004. IP header 2002 includes a source IP address of the sending node (which may be an IP address of the source node or an intermediate node) and a destination IP address of the destination, along with other information. Quantum payload 2004 includes one or more qubits 2006 encoded into the quantum payload, along with one or more identifiers 2008 of the one or more qubits. Quantum payload 2004 may encode each qubit as a photon state (e.g., polarization). The identifiers may include unique identifiers and/or offsets of the individual qubits.

FIG. 21 is an illustration of an example response message 2100 that may be sent from a node to a previous node in response to a packet (e.g., packet 2000) received from the previous node. Response message 2100 includes a source IP address 2102 of the sending node and a destination IP address 2104 of the node that is the target of the response message. Response message 2100 may include a type 2106 to indicate either ACK or NACK, and may also include an identifier 2108 of a corresponding qubit (e.g., that was present in or missing from the packet to which the response message is an answer).

Referring to FIG. 22, FIG. 22 illustrates a hardware block diagram of a computing device 2200 that may perform functions associated with operations discussed herein in connection with the techniques depicted in FIGS. 1-21. In various embodiments, a computing device or apparatus, such as computing device 2200 or any combination of computing devices 2200, may be configured as any entity/entities as discussed for the techniques depicted in connection with FIGS. 1-21 in order to perform operations of the various techniques discussed herein. For example, computing device may represent or be used to implement nodes of quantum network 100.

In at least one embodiment, the computing device 2200 may be any apparatus that may include one or more processor(s) 2202 (e.g., processor 106), one or more memory element(s) 2204 (e.g., memory 108), storage 2206, a bus 2208, one or more network processor unit(s) 2210 interconnected with one or more network input/output (I/O) interface(s) 2212 (e.g., network interface 114), one or more I/O interface(s) 2214, and control logic 2220. In various embodiments, instructions associated with logic for computing device 2200 can overlap in any manner and are not limited to the specific allocation of instructions and/or operations described herein. Computing device 2200 may also include or have access to BSM device 110 and BPG 112.

In at least one embodiment, processor(s) 2202 is/are at least one hardware processor configured to execute various tasks, operations and/or functions for computing device 2200 as described herein according to software and/or instructions configured for computing device 2200. Processor(s) 2202 (e.g., a hardware processor) can execute any type of instructions associated with data to achieve the operations detailed herein. In one example, processor(s) 2202 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 2204 and/or storage 2206 is/are configured to store data, information, software, and/or instructions associated with computing device 2200, and/or logic configured for memory element(s) 2204 and/or storage 2206. For example, any logic described herein (e.g., control logic 2220) can, in various embodiments, be stored for computing device 2200 using any combination of memory element(s) 2204 and/or storage 2206. Note that in some embodiments, storage 2206 can be consolidated with memory element(s) 2204 (or vice versa), or can overlap/exist in any other suitable manner.

In at least one embodiment, bus 2208 can be configured as an interface that enables one or more elements of computing device 2200 to communicate in order to exchange information and/or data. Bus 2208 can be implemented with any architecture designed for passing control, data and/or information between processors, memory elements/storage, peripheral devices, and/or any other hardware and/or software components that may be configured for computing device 2200. In at least one embodiment, bus 2208 may be implemented as a fast kernel-hosted interconnect, potentially using shared memory between processes (e.g., logic), which can enable efficient communication paths between the processes.

In various embodiments, network processor unit(s) 2210 may enable communication between computing device 2200 and other systems, entities, etc., via network I/O interface(s) 2212 (wired and/or wireless) to facilitate operations discussed for various embodiments described herein. In various embodiments, network processor unit(s) 2210 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 2200 and other systems, entities, etc. to facilitate operations for various embodiments described herein. In various embodiments, network I/O interface(s) 2212 can be configured as one or more Ethernet port(s), Fibre Channel ports, any other I/O port(s), and/or antenna(s)/antenna array(s) now known or hereafter developed. Thus, the network processor unit(s) 2210 and/or network I/O interface(s) 2212 may include suitable interfaces for receiving, transmitting, and/or otherwise communicating data and/or information in a network environment.

I/O interface(s) 2214 allow for input and output of data and/or information with other entities that may be connected to computing device 2200. For example, I/O interface(s) 2214 may provide a connection to external devices such as a keyboard (which may be biometric), keypad (which may be biometric), a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 2220 can include instructions that, when executed, cause processor(s) 2202 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 2220) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timepacket. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 2204 and/or storage 2206 can store data, software, code, instructions (e.g., processor instructions), logic, parameters, combinations thereof, and/or the like used for operations described herein. This includes memory element(s) 2204 and/or storage 2206 being able to store data, software, code, instructions (e.g., processor instructions), logic, parameters, combinations thereof, or the like that are executed to carry out operations (including generating GUIs for display and interacting with the GUIs) in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, packets, segments, domains, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4(IPv4 ) and/or IP version 6(IPv6 ) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In some aspects, the techniques described herein relate to a method including: at a node on a path of a quantum network that leads from a source to a destination, propagating quantum entanglement hop-by-hop along the path toward the destination by: establishing a first entanglement link with a previous-hop node on the path; determining a next-hop node on the path based on the destination; attempting to establish a second entanglement link with the next-hop node; and upon receiving an acknowledgement from the next-hop node indicating that the second entanglement link is established, performing an entanglement swap on the first entanglement link and the second entanglement link to establish a third entanglement link between the previous-hop node and the next-hop node.

In some aspects, the techniques described herein relate to a method, further including: reporting, to the previous-hop node, an outcome of the entanglement swap that is to be forwarded to the source.

In some aspects, the techniques described herein relate to a method, wherein: establishing the first entanglement link includes establishing first entanglement between a first quantum memory (QM) of the previous-hop node and a second QM of the node; attempting to establish the second entanglement link includes attempting to establish second entanglement between a third QM of the node and a fourth QM of the next-hop node; and performing the entanglement swap includes performing the entanglement swap on the second QM and the third QM of the node to establish third entanglement between the first QM of the previous-hop node and the fourth QM of the next-hop node.

In some aspects, the techniques described herein relate to a method, further including, at the node, propagating quantum entanglement along the path independent of, and without interacting with, a network controller that is separate from the previous-hop node, the node, and the next-hop node.

In some aspects, the techniques described herein relate to a method, wherein establishing the first entanglement link includes: receiving, from the previous-hop node, a first qubit of a first Bell pair that includes a second qubit that is stored in a first QM of the previous-hop node; and storing the first qubit in a second QM of the node.

In some aspects, the techniques described herein relate to a method, wherein attempting to establish the second entanglement link includes: creating a second Bell pair that includes a third qubit and a fourth qubit; storing the third qubit in a third QM of the node; and transmitting the fourth qubit to the next-hop node to be stored in a fourth QM of the next-hop node.

In some aspects, the techniques described herein relate to a method, further including, at the node: upon receiving, from the next-hop node, a negative acknowledgement that indicates that the fourth qubit was not received, repeating creating, storing, and transmitting.

In some aspects, the techniques described herein relate to a method, further including, at the node: receiving, from the previous-hop node, a packet that includes an address of the destination and the first qubit; and wherein determining the next-hop node includes performing a lookup in a local routing table of a route to the next-hop node based on the address; wherein forwarding includes forwarding the fourth qubit based on the route.

In some aspects, the techniques described herein relate to a method, further including, at the node: upon receiving, from the next-hop node, a negative acknowledgement that indicates the second entanglement link is not established, repeating attempting to establish the second entanglement link until the acknowledgement is received.

In some aspects, the techniques described herein relate to a method, wherein: determining the next-hop node includes performing a lookup of a route to the next-hop node in a local routing table based on an address of the destination, and without acquiring information about the route from a separate network controller.

In some aspects, the techniques described herein relate to a method, further including, at the node: performing a network discovery protocol to construct the local routing table.

In some aspects, the techniques described herein relate to a method, further including: repeating propagating quantum entanglement hop-by-hop along the path toward the destination at successive nodes on the path until the destination is reached to achieve entanglement between the source and the destination.

In some aspects, the techniques described herein relate to an apparatus including: a network interface to communicate with a network; and a processor of a node on a path of a quantum network that leads from a source to a destination, wherein the processor is coupled to the network interface and is configured to perform propagating quantum entanglement hop-by-hop along the path toward the destination by: establishing a first entanglement link with a previous-hop node on the path; determining a next-hop node on the path based on the destination; attempting to establish a second entanglement link with the next-hop node; and upon receiving an acknowledgement from the next-hop node indicating that the second entanglement link is established, performing an entanglement swap on the first entanglement link and the second entanglement link to establish a third entanglement link between the previous-hop node and the next-hop node.

In some aspects, the techniques described herein relate to an apparatus, wherein the processor is further configured to: report, to the previous-hop node, an outcome of the entanglement swap that is to be forwarded to the source.

In some aspects, the techniques described herein relate to an apparatus, wherein the processor is configured to perform: establishing the first entanglement link by establishing first entanglement between a first quantum memory (QM) of the previous-hop node and a second QM of the node; attempting to establish the second entanglement link by attempting to establish second entanglement between a third QM of the node and a fourth QM of the next-hop node; and performing the entanglement swap by performing the entanglement swap on the second QM and the third QM of the node to establish third entanglement between the first QM of the previous-hop node and the fourth QM of the next-hop node.

In some aspects, the techniques described herein relate to a method including: at a node on a path of a quantum network, propagating parallel quantum entanglement hop-by-hop along the path by: establishing M inbound entanglement links with a previous node on the path, where M>2; attempting to establish N outbound entanglement links with a next node on the path, where N>2, resulting in establishing P outbound entanglement links with the next node; and upon determining which of the N outbound entanglement links are the P outbound entanglement links, entanglement-swapping the P outbound entanglement links with P inbound entanglement links of the M inbound entanglement links, to entangle the P outbound entanglement links with P inbound entanglement links.

In some aspects, the techniques described herein relate to a method, wherein: establishing the M inbound entanglement links includes establishing the M inbound entanglement links in parallel; attempting to establish the N outbound entanglement links includes attempting to establish the N outbound entanglement links in parallel; and entanglement-swapping includes entanglement-swapping the P outbound entanglement links with the P inbound entanglement links, to entangle the P outbound entanglement links with the P inbound entanglement links in parallel.

In some aspects, the techniques described herein relate to a method, wherein: establishing the M inbound entanglement links includes entangling M inbound quantum memories of the node with M previous quantum memories of the previous node; attempting to establish the N outbound entanglement links includes attempting to entangle N outbound quantum memories of the node with N next quantum memories of the next node, resulting in entangling P outbound quantum memories out of the N outbound quantum memories with P next quantum memories of the next node; and entanglement-swapping includes entanglement-swapping the P outbound quantum memories with P inbound quantum memories of the M inbound quantum memories, to entangle the P next quantum memories with P previous quantum memories of the M previous quantum memories.

In some aspects, the techniques described herein relate to a method, wherein establishing the M inbound entanglement links includes: receiving, in parallel from the previous node, M inbound qubits of M Bell pairs created in the previous node; and storing the M inbound qubits in M inbound quantum memories of the node.

In some aspects, the techniques described herein relate to a method, wherein attempting to establish the N outbound entanglement links includes: creating N Bell pairs that include N first qubits and N second qubits; storing the N first qubits in N outbound quantum memories of the node; and transmitting, to the next node, the N second qubits in parallel to be stored in N quantum memories of the next node.

In some aspects, the techniques described herein relate to a method, wherein determining includes: receiving, from the next node, an individual acknowledgement for each of the P outbound entanglement links this is established with the next node.

In some aspects, the techniques described herein relate to a method, wherein: entanglement-swapping includes performing Bell-state measurements on pairs of the P inbound entanglement links and the P outbound entanglement links.

In some aspects, the techniques described herein relate to a method, further including: repeating propagating parallel quantum entanglement hop-by-hop along the path at successive nodes on the path to achieve parallel quantum entanglement from end-to-end of the path.

In some aspects, the techniques described herein relate to an apparatus including: a network interface to communicate with a network; and a processor of a node on a path of a quantum network, wherein the processor is coupled to the network interface and is configured to perform propagating parallel quantum entanglement hop-by-hop along the path by: establishing M inbound entanglement links with a previous node on the path, where M>2; attempting to establish N outbound entanglement links with a next node on the path, where N>2, resulting in establishing P outbound entanglement links with the next node; and upon determining which of the N outbound entanglement links are the P outbound entanglement links, entanglement-swapping the P outbound entanglement links with P inbound entanglement links of the M inbound entanglement links, to entangle the P outbound entanglement links with P inbound entanglement links.

In some aspects, the techniques described herein relate to an apparatus, wherein the processor is configured to perform: establishing the M inbound entanglement links by entangling M inbound quantum memories of the node with M previous quantum memories of the previous node; attempting to establish the N outbound entanglement links by attempting to entangle N outbound quantum memories of the node with N next quantum memories of the next node, resulting in entangling P outbound quantum memories out of the N outbound quantum memories with P next quantum memories of the next node; and entanglement-swapping by entanglement-swapping the P outbound quantum memories with P inbound quantum memories of the M inbound quantum memories, to entangle the P next quantum memories with P previous quantum memories of the M previous quantum memories.

In some aspects, the techniques described herein relate to a non-transitory computer readable medium encoded with instructions that, when executed by a processor of a node on a path of a quantum network, causes the processor to perform propagating parallel quantum entanglement hop-by-hop along the path by: establishing M inbound entanglement links with a previous node on the path, where M>2; attempting to establish N outbound entanglement links with a next node on the path, where N>2, resulting in establishing P outbound entanglement links with the next node; and upon determining which of the N outbound entanglement links are the P outbound entanglement links, entanglement-swapping the P outbound entanglement links with P inbound entanglement links of the M inbound entanglement links, to entangle the P outbound entanglement links with P inbound entanglement links.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
at a node on a path of a quantum network that leads from a source to a destination, propagating quantum entanglement hop-by-hop along the path toward the destination by:
establishing a first entanglement link with a previous-hop node on the path;
determining a next-hop node on the path based on the destination;
attempting to establish a second entanglement link with the next-hop node; and
upon receiving an acknowledgement from the next-hop node indicating that the second entanglement link is established, performing an entanglement swap on the first entanglement link and the second entanglement link to establish a third entanglement link between the previous-hop node and the next-hop node.

2. The method of claim 1, further comprising:
reporting, to the previous-hop node, an outcome of the entanglement swap that is to be forwarded to the source.

3. The method of claim 1, wherein:
establishing the first entanglement link includes establishing first entanglement between a first quantum memory (QM) of the previous-hop node and a second QM of the node;
attempting to establish the second entanglement link includes attempting to establish second entanglement between a third QM of the node and a fourth QM of the next-hop node; and
performing the entanglement swap includes performing the entanglement swap on the second QM and the third QM of the node to establish third entanglement between the first QM of the previous-hop node and the fourth QM of the next-hop node.

4. The method of claim 1, further comprising, at the node, propagating quantum entanglement along the path independent of, and without interacting with, a network controller that is separate from the previous-hop node, the node, and the next-hop node.

5. The method of claim 1, wherein establishing the first entanglement link includes:
receiving, from the previous-hop node, a first qubit of a first Bell pair that includes a second qubit that is stored in a first QM of the previous-hop node; and
storing the first qubit in a second QM of the node.

6. The method of claim 5, wherein attempting to establish the second entanglement link includes:
creating a second Bell pair that includes a third qubit and a fourth qubit;
storing the third qubit in a third QM of the node; and
transmitting the fourth qubit to the next-hop node to be stored in a fourth QM of the next-hop node.

7. The method of claim 6, further comprising, at the node:
upon receiving, from the next-hop node, a negative acknowledgement that indicates that the fourth qubit was not received, repeating creating, storing, and transmitting.

8. The method of claim 6, further comprising, at the node:
receiving, from the previous-hop node, a packet that includes an address of the destination and the first qubit; and
wherein determining the next-hop node includes performing a lookup in a local routing table of a route to the next-hop node based on the address;
wherein forwarding includes forwarding the fourth qubit based on the route.

9. The method of claim 1, further comprising, at the node:
upon receiving, from the next-hop node, a negative acknowledgement that indicates the second entanglement link is not established, repeating attempting to establish the second entanglement link until the acknowledgement is received.

10. The method of claim 1, wherein:
determining the next-hop node includes performing a lookup of a route to the next-hop node in a local routing table based on an address of the destination, and without acquiring information about the route from a separate network controller.

11. The method of claim 10, further comprising, at the node:
performing a network discovery protocol to construct the local routing table.

12. The method of claim 1, further comprising:
repeating propagating quantum entanglement hop-by-hop along the path toward the destination at successive nodes on the path until the destination is reached to achieve entanglement between the source and the destination.

13. An apparatus comprising:
a network interface to communicate with a network; and
a processor of a node on a path of a quantum network that leads from a source to a destination, wherein the processor is coupled to the network interface and is configured to perform propagating quantum entanglement hop-by-hop along the path toward the destination by:
establishing a first entanglement link with a previous-hop node on the path;
determining a next-hop node on the path based on the destination;
attempting to establish a second entanglement link with the next-hop node; and
upon receiving an acknowledgement from the next-hop node indicating that the second entanglement link is established, performing an entanglement swap on the first entanglement link and the second entanglement link to establish a third entanglement link between the previous-hop node and the next-hop node.

14. The apparatus of claim 13, wherein the processor is further configured to:
report, to the previous-hop node, an outcome of the entanglement swap that is to be forwarded to the source.

15. The apparatus of claim 13, wherein the processor is configured to perform:
establishing the first entanglement link by establishing first entanglement between a first quantum memory (QM) of the previous-hop node and a second QM of the node;
attempting to establish the second entanglement link by attempting to establish second entanglement between a third QM of the node and a fourth QM of the next-hop node; and
performing the entanglement swap by performing the entanglement swap on the second QM and the third QM of the node to establish third entanglement between the first QM of the previous-hop node and the fourth QM of the next-hop node.

16. A method comprising:
at a node on a path of a quantum network, propagating parallel quantum entanglement hop-by-hop along the path by:
establishing M inbound entanglement links with a previous node on the path, where M>2;
attempting to establish N outbound entanglement links with a next node on the path, where N>2, resulting in establishing P outbound entanglement links with the next node; and
upon determining which of the N outbound entanglement links are the P outbound entanglement links, entanglement-swapping the P outbound entanglement links with P inbound entanglement links of the M inbound entanglement links, to entangle the P outbound entanglement links with P inbound entanglement links.

17. The method of claim 16, wherein:
establishing the M inbound entanglement links includes establishing the M inbound entanglement links in parallel;
attempting to establish the N outbound entanglement links includes attempting to establish the N outbound entanglement links in parallel; and
entanglement-swapping includes entanglement-swapping the P outbound entanglement links with the P inbound entanglement links, to entangle the P outbound entanglement links with the P inbound entanglement links in parallel.

18. The method of claim 16, wherein:
establishing the M inbound entanglement links includes entangling M inbound quantum memories of the node with M previous quantum memories of the previous node;
attempting to establish the N outbound entanglement links includes attempting to entangle N outbound quantum memories of the node with N next quantum memories of the next node, resulting in entangling P outbound quantum memories out of the N outbound quantum memories with P next quantum memories of the next node; and
entanglement-swapping includes entanglement-swapping the P outbound quantum memories with P inbound quantum memories of the M inbound quantum memories, to entangle the P next quantum memories with P previous quantum memories of the M previous quantum memories.

19. The method of claim 16, wherein establishing the M inbound entanglement links includes:
receiving, from the previous node, M inbound qubits of M Bell pairs created in the previous node; and
storing the M inbound qubits in M inbound quantum memories of the node.

20. The method of claim 16, wherein attempting to establish the N outbound entanglement links includes:
creating N Bell pairs that include N first qubits and N second qubits;
storing the N first qubits in N outbound quantum memories of the node; and
transmitting, to the next node, the N second qubits in parallel to be stored in N quantum memories of the next node.
